(19) United States
(12) Patent Application Publication
(10) Pub. No.: US 2011/0222629 A1
(43) Pub. Date: Sep. 15, 2011

(54) PRE-CODING FOR DOWNLINK CONTROL CHANNEL

(75) Inventors: Lars Erik Lindh, Helsingfors (FI); Timo Eric Roman, Espoo (FI); Juha Heiskala, Helsinki (FI); Tommi Tapani Koivisto, Espoo (FI)

(73) Assignee: NOKIA CORPORATION, Espoo (FI)

(21) Appl. No.: 13/130,280

(22) PCT Filed: Nov. 20, 2008
(86) PCT No.: PCT/IB2008/054885

§ 371 Date: May 19, 2011

(51) Int. Cl. H04W 4/00

(52) U.S. Cl. 375/296

(57) ABSTRACT

Precoding information is provided (implicitly or explicitly) to a particular user equipment UE. Closed-loop spatial coding for a control channel is selected for the particular user equipment, and at least one control channel element CCE is determined within the particular user equipment's search space of the control channel that is associated with the provided precoding information. The determined at least one CCE is spatially encoded using the provided precoding information to schedule radio resources for the particular user equipment. The UE determines a search space for a control channel, and from received radio resource control signaling determines at least one CCE within the search space that is to be encoded with closed-loop spatial coding. The UE decodes the determined at least one CCE within the search space using a closed-loop spatial decoding with precoding information associated with the at least one CCE to find radio resources scheduled for the particular UE.

### TECHNICAL FIELD

The exemplary and non-limiting embodiments of this invention relate generally to wireless communication systems, methods, devices and computer programs and, more specifically, relate to multi-antenna techniques for control channel signaling.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project

BLER block error rate

CRC cyclic redundancy check

CSI channel state information

DL downlink (eNB towards UE)

eNB EUTRAN Node B (evolved Node B, a network access node)

EPC evolved packet core

EUTRAN evolved UTRAN (also known as LTE or 3.9G)

LTE long term evolution

MAC medium access control

MM/MME mobility management/mobility management entity

PDCCH physical downlink control channel

PDCP packet data convergence protocol

PDSCH physical downlink shared channel

PHY physical

PMI precoding matrix index

PUCCH physical uplink control channel

PUSCH physical uplink shared channel

RLC radio link control

RNTI radio network temporary identifier

RRC radio resource control

UE user equipment

UL uplink (UE towards eNB)

UTRAN universal terrestrial radio access network

A communication system known as evolved UTRAN (EUTRAN, also referred to as UTRAN-LTE or as E-UTRA) is currently under development within the 3GPP. As presently specified in Release 8 (Rel-8) the DL access technique will be orthogonal frequency division multiple access (OF DMA), and the UL access technique will be single carrier, frequency division multiple access (SC-FDMA).

One specification of interest is 3GPP TS 36.300, V8.6.0 (2008-09), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8), incorporated by reference herein in its entirety.

FIG. 1 reproduces FIG. 4.1 of 3GPP TS 36.300, and shows the overall architecture of the E-UTRAN system. The EUTRAN system includes eNBs, providing the EUTRA user plane (PDCP/RLC/MAC/PHY) and control plane (RRC) protocol terminations towards the UE. The eNBs are interconnected with each other by means of an X2 interface. The eNBs are also connected by means of an S1 interface to an EPC, more specifically to a MME (Mobility Management Entity) by means of a S1 MME interface and to a Serving Gateway (SGW) by means of a S1 interface. The S1 interface supports a many to many relationship between MMEs/Serving Gateways and eNBs.

The eNB hosts the following functions:
functions for Radio Resource Management: Radio Bearer Control, Radio Admission Control, Connection Mobility Control, Dynamic allocation of resources to UEs in both uplink and downlink (scheduling);
IP header compression and encryption of the user data stream;
selection of a MME at UE attachment;
routing of User Plane data towards Serving Gateway;
scheduling and transmission of paging messages (originated from the MME);
scheduling and transmission of broadcast information (originated from the MME or O&M); and
a measurement and measurement reporting configuration for mobility and scheduling.

Now 3GPP is starting the standardization process of LTE Rel-9 and LTE-Advanced, which is intended to contain functionalities beyond the LTE Rel-8 system. The only multi-antenna technique that LTE Rel-8 uses for the PDCCH is open-loop transmit diversity. For further details of the DL control channel, see for example 3GPP TS 36.211 v8.4.0 (2008-09); 3GPP TS 36.212 v8.4.0 (2008-9); and 3GPP TS 36.213 v8.4.0 (2008-9). LTE Rel-8 uses closed-loop multi-antenna pre-coding only for the transmission of data over the PDSCH (for UEs that are configured for this transmission mode).

Document no. R1-073370 entitled SUPPORT OF PRECODING FOR E-UTRA DL L1/L2 CONTROL CHANNEL (3GPP TSG RANI #50, Athens, Greece; Aug. 20-24, 2007; by Motorola) proposes pre-coding for the PDCCH in the context of LTE Rel-8 standardization. However, the underlying assumption throughout that document is that the UE reports a preferred pre-coding to the eNB, which applies that UE-reported preferred pre-coding, and which is expected by the UE when it decodes the PDCCH. This assumption is not so assured in practice though; the reporting of pre-coding information by the UEs cannot always be assumed to be done over an error-free channel. For example, wideband PMI reports on the PUCCH are not CRC-protected.

What is needed in the art is an alternative to the current open-loop transmit diversity for multi-antenna transmissions on a control channel, an alternative which is robust and practical to implement and which addresses some shortfalls of the open-loop diversity scheme now in use for Rel-8.

### SUMMARY

The foregoing and other problems are overcome, and other advantages are realized, by the use of the exemplary embodiments of this invention.

In an exemplary embodiment of the invention there is a method that includes providing to a particular user equipment precoding information; selecting closed-loop spatial coding for a control channel for the particular user equipment; determining at least one control channel element within the particular user equipment's search space of the control channel that is associated with the provided precoding information; and spatially coding the determined at least one control channel element using the provided precoding information to schedule radio resources for the particular user equipment.

In another exemplary embodiment of the invention there is a computer readable memory storing a program executable by a processor to perform actions which include providing to a particular user equipment precoding information; selecting closed-loop spatial coding for a control channel for the particular user equipment; determining at least one control channel element within the particular user equipment's search space of the control channel that is associated with the provided precoding information; and spatially coding the determined at least one control channel element using the provided precoding information to schedule radio resources for the particular user equipment.

In yet another exemplary embodiment of the invention there is an apparatus that includes a memory, a processor and an encoder. The memory stores an association of at least one control channel element to precoding matrices. The processor is configured to determine precoding information to provide to a particular user equipment, to select closed-loop spatial coding for a control channel for a particular user equipment, and to determine at least one control channel element within the particular user equipment's search space of the control channel that is associated in the memory with the precoding information. The encoder is configured to spatially encode the determined at least one control channel element using the precoding matrix in the memory that is associated with the at least one control channel element for scheduling radio resources for the particular user equipment.

In still another exemplary embodiment of the invention there is an apparatus that includes storage means (e.g., a computer readable memory), processing means (e.g., a processor, a digital signal processor, etc.) and encoding means (e.g., an encoder). The storage means is for storing an association of at least one control channel element to precoding matrices. The processing means is for determining precoding information to provide to a particular user equipment, for selecting closed-loop spatial coding for a control channel for a particular user equipment, and for determining at least one control channel element within the particular user equipment's search space of the control channel that is associated in the storage means with the precoding information. The encoding means is for spatially encoding the determined at least one control channel element using the precoding matrix in the storage means that is associated with the at least one control channel element for scheduling radio resources for the particular user equipment.

In a further exemplary embodiment of the invention there is a method that includes determining for a user equipment a search space for a control channel; determining from received radio resource control signaling at least one control channel element within the search space that is to be encoded with closed-loop spatial coding; and decoding the determined at least one control channel element within the search space using a closed-loop spatial decoding with precoding information associated with the at least one control channel element to find radio resources scheduled for the particular user equipment.

In yet a further exemplary embodiment of the invention there is an apparatus that includes a processor and a decoder. The processor is configured to determine a search space for a control channel, and to determine from received radio resource control signaling at least one control channel element within a user equipment search space that is to be encoded with closed-loop spatial coding. The decoder is configured to decode the at least one control channel element within the search space using a closed-loop spatial decoding with precoding information associated with the at least one control channel element to find radio resources scheduled for the user equipment.

### BRIEF DESCRIPTION OF THE DRAWINGS

FIG. 1 reproduces FIG. 4 of 3GPP TS 36.300, and shows the overall architecture of the E-UTRAN system.

FIG. 2 is a process flow diagram showing generation of a control channel (PDCCH) according to an exemplary embodiment of this invention.

FIG. 3 is a graph showing block error rate performance as a function of signal-to-noise ratio for PDCCH Format 1A (43 bit payload) with transmit diversity versus closed-loop rank-1 wideband precoding, assuming 2 or 4 transmit antennas at eNB and 2 receive antennas at the UE and with PDCCH aggregation level set to 1.

FIG. 4 is a graph similar to FIG. 3, but with PDCCH aggregation level set to 2.

FIG. 5 is a graph similar to FIG. 3, but with PDCCH aggregation level set to 8.

FIG. 6 is a schematic diagram illustrating closed-loop pre-coding for PDCCH with RRC signaling of UE specific PMI according to an exemplary embodiment of the invention detailed herein as mode 1.

FIG. 7 is a schematic diagram similar to FIG. 6, but with transmit diversity as default/fall-back mode to closed-loop pre-coding according to an exemplary embodiment detailed herein as mode 2.

FIG. 8 is a schematic diagram similar to FIG. 6, but with implicit PMI signaling for PDCCH transmission via UE-allocated CCE positions, while allowing transmit diversity as default/fall-back mode as in FIG. 7, according to an exemplary embodiment detailed herein as mode 3.

FIG. 9A shows a simplified block diagram of various electronic devices that are suitable for use in practicing the exemplary embodiments of this invention.

FIG. 9B shows a more particularized block diagram of a user equipment such as that shown at FIG. 9A.

FIG. 10 is a logic flow diagram that illustrates the operation of a method, and a result of execution of computer program instructions embodied on a computer readable memory, in accordance with the exemplary embodiments of this invention.

### DETAILED DESCRIPTION

One area for potential improvement in Rel-9 over Rel-8 is the downlink control channel where multi-antenna techniques beyond Rel-8 transmit diversity could be further utilized. The inventors consider that the coverage and capacity of the physical downlink control channel (PDCCH) in LTE Rel-8 could be considerably improved.

As a preliminary matter, it is to be noted that while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems such as for example UTRAN, GSM, WCDMA, etc., or in wireless systems yet to be developed.

Further, the various names used for the described parameters (e.g. PMI, CRC, etc.) are not intended to be limiting in any respect, as these parameters may be identified by any suitable names. Further, the various names assigned to different channels (e.g., PDCCH) are not intended to be limiting in any respect, as the various channels of either the E-UTRAN system or other wireless systems may be identified by any suitable names.

One important aspect of these teachings is the specific signaling (which may be implicit or explicit) that allows reliable operation of closed-loop pre-coding for a control channel in wireless networks (e.g., the PDCCH in LTE-Advanced networks). Embodiments of this invention employ closed-loop pre-coding, in addition to transmit (tx)-diversity, in the downlink control signaling. One technical advantage of this is an improvement in the coverage and in spectral efficiency, as compared to using only open-loop transmit diversity on the multi-antenna DL control channel transmissions.

Pre-coding is based on the observation that if the eNB has knowledge of the channel state information CSI then the transmission channel can be coded or transformed at the transmitter side to obtain a better more efficient transmission. Pre-coding using that reported CSI can therefore improve spectral efficiency. It is assumed that the UE measures and reports the CSI to the eNB for embodiments of these teachings.

Stated somewhat generally, according to certain embodiments of the invention there is a selection made between open-loop spatial coding (e.g., multi-antenna transmit diversity) and closed-loop spatial coding technique (e.g., multi-antenna pre-coding based on CSI) for a control channel, and then the selected spatial coding is used on the control channel (e.g., the PDCCH) to schedule radio resources (e.g., the PDSCH and/or PUSCH).

Pre-coding can be both wideband (i.e. the same transmission pre-coding weights are used over the whole system bandwidth) and frequency selective (the transmission pre-coding weights differ from one frequency chunk to another, where the chunk size of pre-coding granularity is a parameter to be adjusted).

According to embodiments of this invention, each PDCCH (for each UE) in the downlink control channel can be transmitted either with transmit diversity or closed-loop pre-coding at the discretion of the eNB. One important difference between these two spatial coding methods/techniques is that they use transmit antenna weights as well as different mappings to resource elements. As noted above, transmit-diversity is an open-loop technique, whereas pre-coding is a closed-loop technique which requires channel state information reported by the UE.

In an embodiment, the format of the downlink control information and the channel coding is the same in both cases, it is only the spatial coding of the PDCCH that differs. PDCCHs that are spatially encoded using transmit diversity can be multiplexed in the same subframe with PDCCHs that are spatially encoded using closed-loop pre-coding.

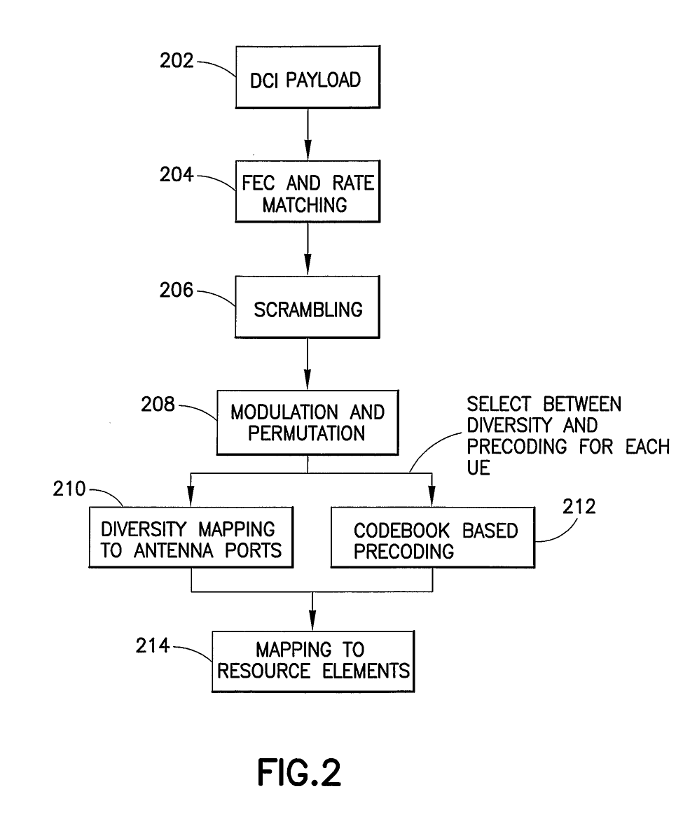

FIG. 2 is a high level block diagram showing process steps for the selective spatial coding in the eNB, supporting both combined pre-coded and transmit-diversity. Specifically, at block 202 the payload for the downlink control information (DCI) and the DCI format is determined. At block 204 the forward error control (e.g., CRC, parity bits, etc.) and rate matching for the PDCCH are determined. At blocks 206 and 208 the PDCCH is scrambled and modulated/permutated, respectively. Then a selection is made as to which spatial diversity coding is to be used: diversity mapping to antenna ports (open-loop) at block 210, or pre-coding according to a codebook of pre-coding matrix indices PMI at block 212. Then at block 214 the PDCCH is mapped to resource elements and thereafter transmitted over the air interface to the UE for which the selection was made.

An important consideration for certain embodiments is that the choice of spatial coding is made by the eNB on a per-UE basis. Below are detailed different ways to make this choice, including the terminal type. For example, in an embodiment block 210 will always be selected for Rel-8 compliant terminals and for Rel-9/LTE-Advanced compliant terminals the selection as between blocks 210 and 212 may be made based on the validity of CSI reported by that terminal, which validity may depend on speed of the terminal. The selection as between blocks 210 and 212 show that the subcarriers belonging to an open-loop transmit-diversity pre-coded PDCCH are spatially coded in a different way than the subcarriers belonging to a closed-loop pre-coded PDCCH. In order to ensure backward compatibility with Rel-8 UEs/mobile terminals which may be operating in LTE-Advanced networks where there are both LTE Rel-8 and LTE-Advanced terminals, the LTE Rel-8 terminals look for LTE Rel-8 PDCCH (which are transmitted using open-transmit diversity pre-coding by the above example) but the LTE-Advanced terminals will look for both LTE Rel-8 and LTE-Advanced PDCCHs (that can either use open-loop or closed-loop pre-coding according to the above example).

There are at least two different embodiments of how the closed-loop pre-coding may be accomplished: wideband and frequency selective. In the wideband pre-coding embodiment, the same spatial mapping is used for all subcarriers used for pre-coding. In the frequency selective embodiment, the mapping is different for different parts of the frequency band. The wideband embodiment is seen to be better attuned for a LTE-Advanced deployment. This is because a PDCCH is permutated over the whole bandwidth. However, the frequency selective embodiment for the closed-loop pre-coding may be readily implemented, even in LTE-Advanced, if such report is available from the UE. UE reports for both wideband and frequency selective pre-coding are within the bounds of LTE Rel-8.

Another criterion by which the selection between open-loop and closed-loop spatial coding may be done is the speed of the UE for which the PDCCH is intended. Closed-loop pre-coding for PDCCH is more appropriate for low-mobility UEs (e.g., those in a building rather than in a moving vehicle). For high mobility UEs, transmit diversity spatial coding is more appropriate because the UE reported pre-coding feedback quickly becomes outdated with fast channel variation over time. Thus for a fast moving UE the reported CSI is valid over a much shorter period of time. CSI reports from a low mobility UE and a high mobility UE will then have different coherence intervals over which they are valid and so the next PDCCH to the high mobility UE may be outside that coherence interval. Consider an example. The eNB may choose transmit diversity for the fast moving UE and pre-coding for the slow moving UE in a case where both UEs reported their CSI at roughly the same time and also where the eNB sends their PDCCHs at roughly the same time, because the eNB will see that the fast moving UE's CSI is no longer valid at the time the eNB must send the next PDCCH to it. There are various ways in which the eNB may obtain the UE's speed information, many of which are known in the art: the UE can report its speed; the eNB may estimate the UE's speed from the UE's radio signals, etc.

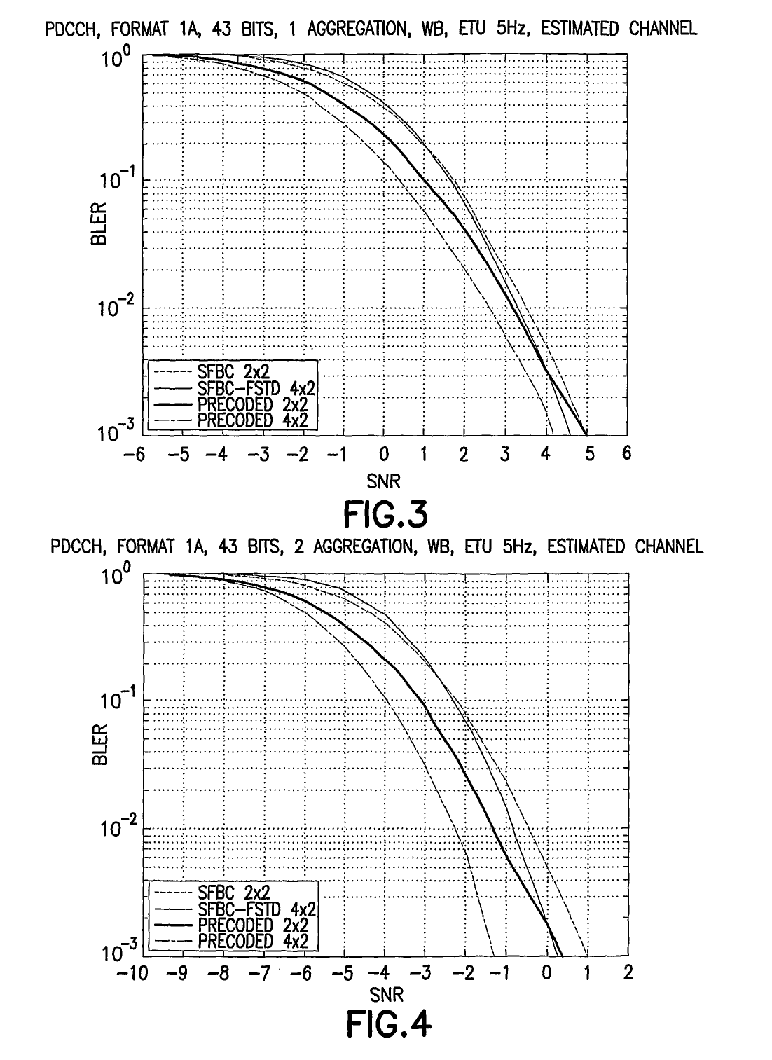

The inventors have quantified the benefits of applying pre-coding to PDCCH transmission via link-level simulations. FIGS. 3, 4 and 5 illustrate the block error rate performance as a function of the SINR for PDCCH DCI format 1A (assuming 43 bit payload): transmit diversity for PDCCH [as defined for PDCCH in 3GPP TS 36.211 v8.4.0 (2008-09), Sections 6.3.4.3 and 6.8.4] is compared to closed-loop rank-1 wideband precoding (as defined in the same standard, Sections 6.3.4.2.1 and 6.3.4.2.3).

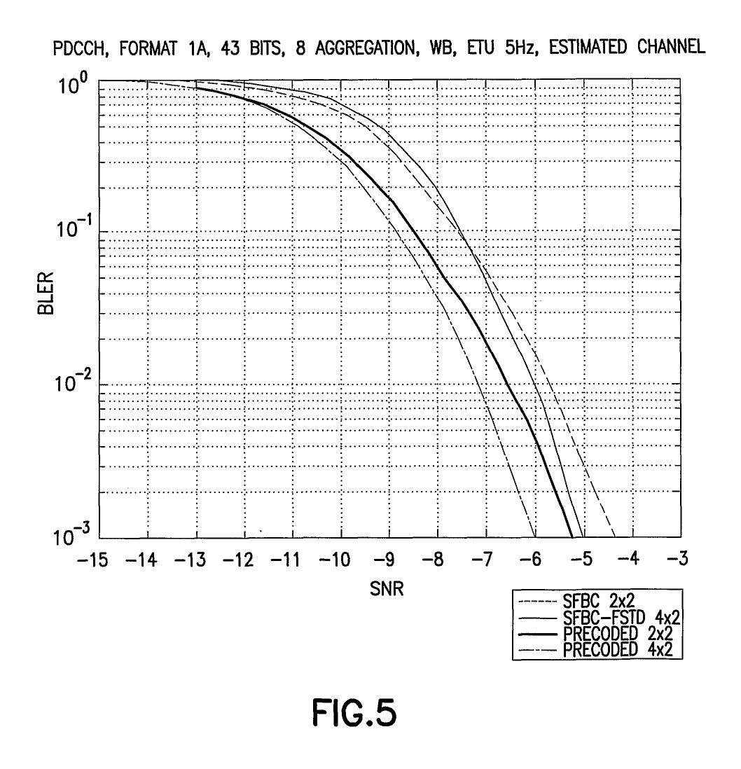

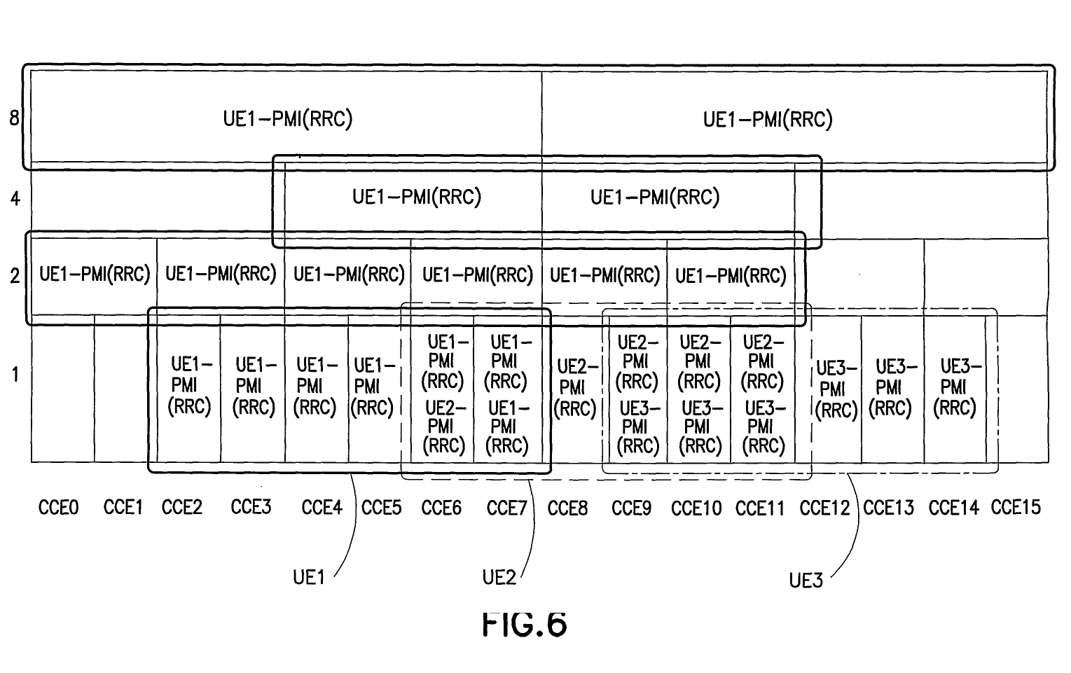

Specifically, FIGS. 3, 4 and 5 show block error rate performance as a function of signal-to-noise ratio for PDCCH Format 1A (43 bit payload) with transmit diversity (SFBC or SFBC-FSTD) versus closed-loop rank-1 wideband precoding, assuming 2 or 4 transmit antennas at eNB and 2 receive antennas at the UE. For FIG. 3 the PDCCH aggregation level is set to 1. For FIG. 4 the PDCCH aggregation level is set to 2. For FIG. 5 the PDCCH aggregation level is set to 8.

The gains observed at the link level for closed-loop rank-1 pre-coding with respect to currently defined transmit diversity for PDCCH are summarized in the table below.

TABLE 1
Gain [dB] of wideband closed-loop rank-1 pre-coding versus transmit
diversity for PDCCH transmission in LTE Rel. 8 (1% target BLER).

| | Gain [dB] at 1% BLER | |
|---|---|---|
| PDCCH | of 2 × 2 closed-loop | Gain [dB] at 1% BLER of 4 × 2 |
| aggregation | rank-1 precoding | closed-loop rank-1 precoding |
| level | vs. 2 × 2 Tx diversity | vs. 4 × 2 Tx diversity |
| 1 | ~0.3 dB | ~0.7 dB |
| 2 | ~0.9 dB | ~1.5 dB |
| 8 | ~0.7 dB | ~1.2 dB |

On the basis of these results it is seen that wideband pre-coding enhances the BLER performance of the downlink control channel (for all considered aggregation levels), and thereby its capacity as well as its coverage. While not specifically quantified herein, it is reasonable to expect that frequency-selective precoding can lead to further improvements in performance.

Now are detailed different embodiments to implement in practice the closed-loop pre-coding option. These embodiments go to how the eNB, which selects to use closed-loop pre-coding for a particular PDCCH for a particular UE, informs the UE of the pre-coding choice that it has made. There are ways to make the closed-loop pre-coding operation transparent to the UEs. In one example, dedicated reference symbols are used that embed the applied pre-coding, and therefore allow the UEs to estimate directly the equivalent channel (i.e. the wireless channel corresponding to the pre-coded PDCCH transmission) and subsequently demodulate the transmitted information.

In LTE Rel-8, the control channel is decoded blindly. That is, each UE searches at different locations, which in LTE Rel-8 is defined by a hashing function, for its own PDCCHs. There is both a common and a UE dedicated search space, and Rel-8 stipulates that the UE shall be able to do 44 blind decoding attempts in a subframe. The hashing function tells each UE which CCEs to monitor (i.e. decode) for a potential PDCCH transmission, given the subframe number, a common or UE-specific search space and the aggregation level (1, 2, 4, or 8).

According to current LTE Rel. 8 specifications (Section 9.1.1 of 3GPP TS 36.213 v8.4.0 (2008-09)), the control region consists of a set of CCEs, numbered from 0 to N_{CCE,k}−1 according to Section 6.8.2 in 3GPP TS 36.211 v8.4.0 (2008-09), where N_{CCE,k} is the total number of CCEs in the control region of subframe k. The set of PDCCH candidates to monitor are defined in terms of search spaces, where a search space Sₖ^{(L)} at aggregation level Lε{1, 2, 4, 8} is defined by a set of PDCCH candidates. The CCEs corresponding to PDCCH candidate m of the search space Sₖ^{(L)} are given by

L·{(Yₖ+m)mod └N_{CCE,k}/L┘}+i,

where Yₖ is defined below, i=0, . . . , L−1 and m=0, . . . , M^{(L)}−1. M^{(L)} is the number of PDCCH candidates to monitor in the given search space (see Table 9.1.1-1 in 3GPP TS 36.213 v8.4.0 (2008-09)).

For the common search spaces, Yₖ is set to 0 for the two aggregation levels L=4 and L=8. For the UE-specific search space Sₖ^{(L)} at aggregation level L, the variable Yₖ is defined by

Yₖ=(A·Yₖ₋₁)mod D,

where Y₋₁=n_{RNTI}≠0, A=39827 and D=65537.

According to certain embodiments of these teachings at least some UEs (for example, a UE that is compliant with LTE-Advanced) will have to search for both transmit-diversity spatial coded PDCCHs and also for closed-loop pre-coded PDCCHs. Although the number of blind decoding attempts can increase due to this dual nature of the UE's search, there are a number of ways to avoid the number of blind decoding attempts increasing too much.

Some exemplary approaches to control the blind decoding attempts that may become necessary at the UE include:
Allowing only pre-coded PDCCHs for those UEs that have reported their CSI within a reasonably short time period e.g. 10 subframes. (It is generally not desirable to pre-code with potentially outdated pre-coding feedback information, as in the fast-moving UE example above)
Allowing pre-coded PDCCHs only in the dedicated search space, not the common search space.
In order to use pre-coded PDCCHs a UE shall be configured for that (e.g. via RRC signaling).
Potentially only certain subframes could be eligible for pre-coded PDCCHs.
Pre-coding could potentially be implicitly signaled by the position of CCEs used by the PDCCH (this is detailed further below).
Potentially only a subset of all PMIs are allowed in the implicit signaling, so that the UE does not need to check all of them. The subset can be configured via RRC signaling.

Signaling of the pre-coding information to the UEs is an important aspect of certain embodiments of these teachings. In the examples below, it is assumed that closed-loop pre-coding is performed as defined in 3GPP TS 36.211 v8.4.0 (2008-09), Sections 6.3.4.2.1 and 6.3.4.2.3. Common reference symbols are used for channel estimation purposes at the UE.

Now, the UE also needs information on the pre-coding currently applied by the eNB in order to equalize the equivalent transmission channel (which includes the effects of pre-coding) and further in order to demodulate its pre-coded PDCCH transmission. The pre-coding information may in some embodiments be conveyed in the form of a pre-coding matrix index (PMI) which points to a pre-defined pre-coding vector within the pre-coding codebook which is known to both the eNB and the UE. This PMI is assumed for the specific implementations detailed below, some of which entail explicit signaling and some of which entail implicit signaling of this PMI information.

MODE 1: CLOSED-LOOP PRECODING FOR PDCCH WITH RRC SIGNALING OF UE SPECIFIC PMI. In accordance with one embodiment of the invention, the UE is configured to use closed-loop pre-coding for PDCCH transmissions targeted to them. In this mode, the eNB will notify the UEs via higher layer signaling of which pre-coding matrix index/indices (PMI or PMIs) (i.e. the pre-coding vector or vectors) they should assume for PDCCH transmissions targeted to them. The selection of PMI(s) for each UE can be made on the basis of PMI reports from the UE to the eNB.

With the embodiment of wideband pre-coding, a single PMI may be reported for the whole frequency band. For the embodiment of frequency-selective pre-coding, a set of PMIs may be reported, each corresponding to a specified sub-band/frequency chunk. A further option by which to select the PMI(s) includes exploiting uplink/downlink channel reciprocity e.g. in time domain duplex TDD systems.

For embodiments which use RRC based signaling/higher layer signaling to get the PMI information to the UE, the RRC message can be delivered with a low-latency to the UE and is CRC protected and hence reliable. Furthermore it is acknowledged by the UE. Hence both eNB and UE would have the same understanding on which PMI(s) is (are) currently used, and antenna weight verification would not be required at the UE.

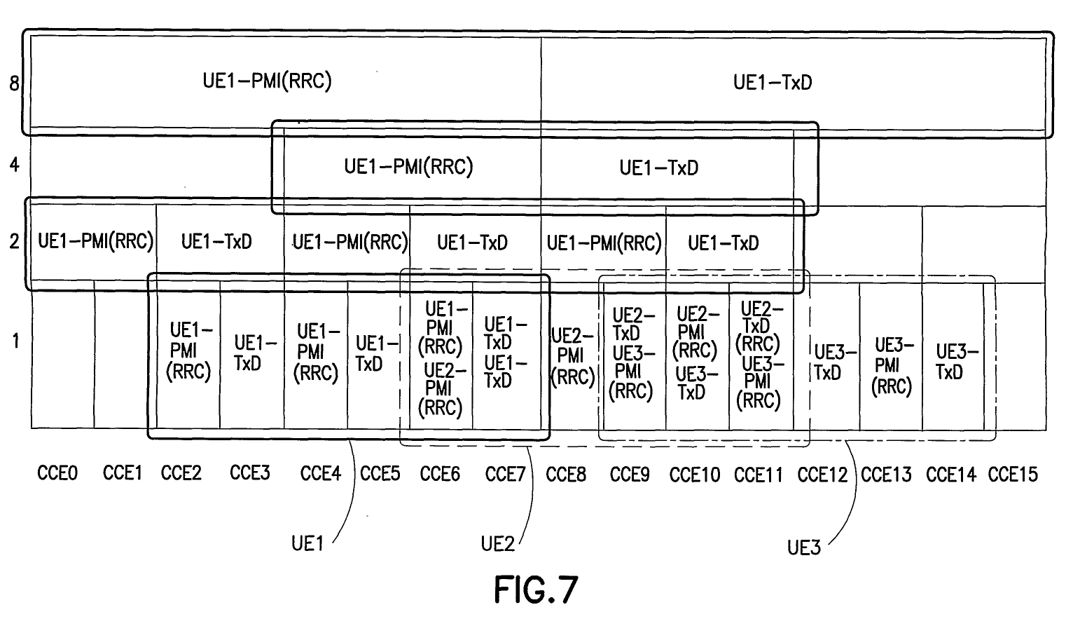

FIG. 6 illustrates one exemplary allocation of PDCCHs among the 4 defined aggregation levels (1, 2, 4 and 8) for a total of 3 UEs, each configured to receive a pre-coded PDCCH. Prior to that, the information on UE-specific applied PMI(s) has been delivered to each UE via RRC signaling and acknowledged by UEs.

Specifically, at FIG. 6 for aggregation 1, UE#1 has a dedicated search space that spans CCE #s 2 through 7; UE#2 has a dedicated search space that spans CCE #s 6 through 11; and UE#3 has a dedicated search space that spans CCE #s 9 through 14. The eNB may send the closed-loop spatially coded PDCCH to the individual UE in any of those CCEs of the UE's dedicated search space. In one embodiment as noted above, the closed-loop spatially coded PDCCH is restricted only to those UE-specific dedicated CCEs, and is not sent in any of the common CCEs.

FIG. 6 also shows the dedicated search spaces in aggregation levels 2, 4 and 8, for which any of the CCEs for these aggregation levels may be used for sending the closed-loop spatially encoded PDCCH to the UE having that aggregation level. The UE knows in advance its aggregation level, and therefore its search space, and attempts for each of those CCEs in its dedicated search space to decode the PDCCH using the closed-loop technique and the RRC-signaled PMI. If this fails the UE can then attempt to decode using transmit diversity.

MODE 2: CLOSED-LOOP PRECODING FOR PDCCH WITH RRC SIGNALING OF UE SPECIFIC PMI, WHILE ALLOWING TRANSMIT DIVERSITY AS FALL-BACK MODE. This mode is similar to mode 1 detailed above and at FIG. 6, except that for each UE configured via RRC signaling to receive a pre-coded PDCCH transmission, some of the possible CCE allocations are tied to the use of pre-coding information indicated via RRC signaling while remaining CCEs point exclusively to the use of transmit diversity for PDCCH [e.g., where transmit diversity may be defined as in the Rel-8 PDCCH, see 3GPP TS 36.211 v8.4.0 (2008-09)]. Transmit diversity may be used as fall-back mode and would still allow proper PDCCH reception. This may be advantageous for the case where the eNB detects that the PMI(s) are erroneous or outdated.

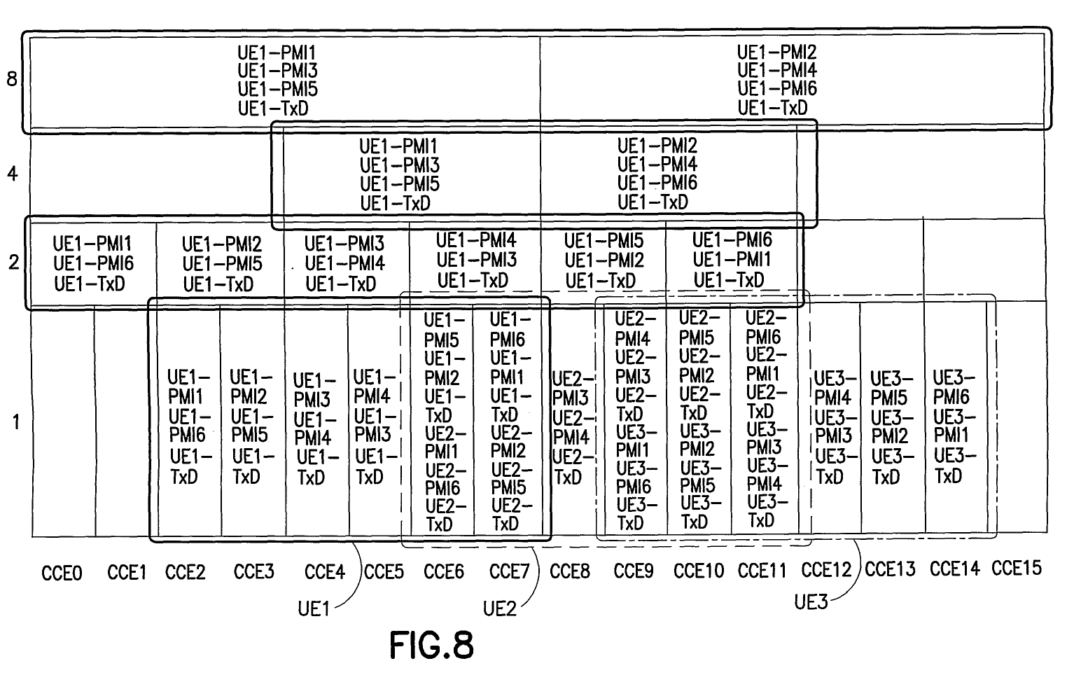

This is shown by example at FIG. 7. In this example, for UE#1 in aggregation level 1, CCE #s 3, 5 and 7 are reserved for transmit diversity and that UE need not look/blindly decode in those CCEs for a closed-loop pre-coded CCE. Similarly, for UE#2 under aggregation level 1, CCE #s 7, 9 and 11 are reserved for transmit diversity PDCCHs. Note that the reservation for fall back transmit diversity need not apply for all UEs in the same CCE; CCE #s 9 and 11 are reserved for transmit diversity PDCCHs for UE2 but not for UE3, and the reverse arrangement is seen at CCE#10.

By reserving certain CCEs (per UE) for transmit diversity, that UE need not search (blindly decode) for a closed-loop pre-coded PDCCH in those reserved CCEs and the scope of its blind decoding is less expanded as compared to if the eNB had the flexibility to put the closed-loop pre-coded PDCCH in any of the dedicated or common CCEs of that UE's search space. It is noted that the number of blind decoding attempts at the UE does not increase at all compared to LTE Rel-8 for this embodiment.

In another embodiment, the eNB may send to a particular UE a PDCCH in any of the CCEs in that UE's search space using transmit diversity (as it can in Rel-8). In this variation, the eNB may use transmit diversity only as a fall-back mode, and the particular UE is understood to first try to decode in those CCEs associated with closed-loop pre-coding with the assumed PMI and if that decoding attempt fails the same UE then tries another decoding looking to those CCEs of its search space that are not exclusively reserved for closed-loop pre-coding (if any are) and assuming transmit diversity.

Another particularly elegant embodiment combines the RRC signaling and the CCE mapping in a smart way. For example, the CCEs in which closed-loop pre-coding may be used by the eNB (and which the UE must blindly decode) is mapped to the PMI signaled by the RRC signaling. In this case, the eNB may need a bit more flexibility than a single PMI, so instead of a single PMI the eNB signals a subset of PMIs. Once the UE reports the PMI in the uplink, the eNB picks a (small) subset of PMIs and signals this subset to the UE via RRC. These PMIs in the subset are mapped to CCEs in a predefined way, and the PDCCH is sent with closed-loop pre-coding to the UE in the CCEs that map to a PMI of the signaled subset. The ‘smart’ way that the eNB selects the subset of PMIs is to use the vectors in the immediate “neighborhood” of the one that the UE has reported. That's because these are the most likely ones that will be used once the radio channel changes (e.g., the most likely ones that the UE will report later).

This embodiment avoids frequent RRC signaling of different PMIs in each case, though it is anticipated that the signaled PMI subset would need to be changed from time to time. This also avoids an excessive amount of blind decoding that the UE may need to do to find the proper PDCCH, while still leaving the eNB sufficient flexibility to find a good closed-loop pre-coding candidate. Of course, this embodiment may also use to transmit diversity fallback mode in which certain CCEs are reserved for transmit diversity PDCCHs and the eNB will not use, and the UE will not blindly decode for closed-loop pre-coded PDCCHs in those reserved CCEs. It may be that the PMI reported by the UE is not in the active PMI subset (and also since PMI on the PUCCH is not CRC-protected). Since RRC signaling is anyway error-proof in that forward error coding together with cyclic redundancy check coding is used, both the eNB and the UE should always have the common knowledge about the precoding vectors in the set.

MODE 3: IMPLICIT PMI SIGNALING FOR PDCCH TRANSMISSION VIA UE-ALLOCATED CCE POSITIONS, WHILE ALLOWING TRANSMIT DIVERSITY AS FALL-BACK MODE. This third mode assumes that UEs are configured to receive their respective PDCCH transmissions in a closed-loop pre-coded manner. Here, the PMI information is implicitly signaled to the UEs and is tied to the CCE positions to which the UE is allocated. Based on the PMI feedback from the UEs, the eNB may follow the UE recommendations by assigning to them CCE positions corresponding to the reported PMIs. The correspondence between a given CCE position and the PMI(s) tied to that CCE is predefined and known in advance to both the UE and the eNB. In this mode the signaling to the UE of its aggregation level (which defines its search space) is the implicit signaling of the PMI(s) to use for the individual CCEs in that search space.

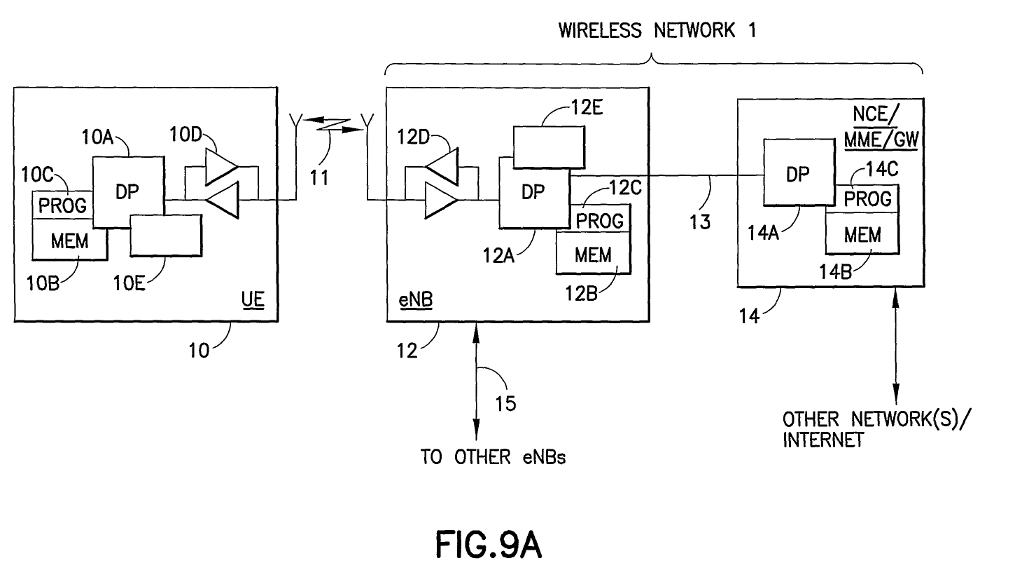

This is shown by example at FIG. 8, which shows implicit PMI signaling for PDCCH transmissions via UE-allocated CCE positions (e.g., according to the UE's assigned aggregation level), with transmit diversity as a fall back mode similar to mode 2 above. For example, UE1 is given aggregation level 1 for which its dedicated search space spans CCE #s 2 through 7. There is an implicit mapping from that aggregation level and those CCEs that CCE1 maps to PMI 1 and PMI16; and that CCE2 maps to PMI12 and PMI15; and so forth as shown in FIG. 8. The UE1 will blindly decode CCE2 using PMI1 and PMI16; and will also blindly decode CCE3 using PMI 12 and PMI15, and so forth. If UE1 does not find a PDCCH for itself in any of those CCEs of its dedicated (or common) CCEs, then it will also look to those same CCEs for its PDCCH using transmit diversity.

This may result in an increased probability of blocking, such as for example where two UEs configured for pre-coding for PDCCH have overlapping CCE spaces and they both need the same PMI(s). This situation may be obviated by allowing multiple possible PMIs to be tied to a specific CCE, as is shown in each of CCE2 through CCE 7 for UE1 in FIG. 8. Note at CCE10 that both UE2 and UE3 will blindly decode using PMI2 and PMI5. The eNB can avoid such blocking because there are two PMIs in that CCE to choose from for the two UEs, and it may choose to pre-code the PDCCH for UE2 in CCE10 using PMI2 and to pre-code the PDCCH for UE3 in that same CCE10 using PMI5. Having more than one PMI mapped to a particular CCE may result in the UE having to perform potentially a higher number of blind detections, as the UE would need to blindly try as many hypotheses as the number of PMIs that are tied to a potential CCE allocation. However, this increase in complexity should be acceptable and not excessive, given the gains provided by pre-coding, and the fact that this increase is small compared to full blind decoding (without any grouping of PMIs) with a large pre-coding codebook. For example, currently there are four entries in the 2 transmit-antenna Rel-8 rank-1 codebook, and sixteen entries in the 4 transmit-antenna Rel-8 rank-1 codebook. The usage of transmit diversity may be tied as well to part or all the CCE positions, and can serve as a fall-back-mode as was detailed above with respect to mode 2 and FIG. 7.

These are examples only; the above teachings can be readily extended to the 8 transmit antenna case, using a corresponding 8 transmission-antenna codebook. However, the implicit signaling of the PMI is not seen to scale so simply with very large codebooks, unless the UE is to be expected to perform a significantly larger amount of blind decoding attempts. This issue may be readily solved by using only a portion (i.e. a subset) of the codebook for PDCCH pre-coding purposes. Particularly where the subset is smartly selected as detailed above, this approach can still achieve the desired pre-coding gain while not excessively increasing the UE's requirements for blind decoding.

It is noted that, for any of modes 1 through 3 above, is that if wideband PMI is signaled for a UE's PDCCH (either implicitly or explicitly), the same wideband PMI can be applied to the associated PDSCH transmission. As with the current version of LTE Rel-8, the PMI index within the PDCCH may contain the whole wideband PMI information to be used for the PDSCH. In another specific embodiment according to these teachings, the PMI index contains some differential information, in case only a subset of the codebook is used for PDCCH pre-coding as is detailed above. This may be addressed by a further antenna weight (PMI) verification at the UE.

As may be seen from the description above, the various embodiments of these teachings achieve the technical advantages of improved capacity and coverage of the DL control channel. In LTE the DL control channel has been estimated by the inventors herein to be suboptimal, needing significant time/frequency resources to give enough coverage. The potential increases to the UE's number of blind decoding attempts are addressed above in the various modes.

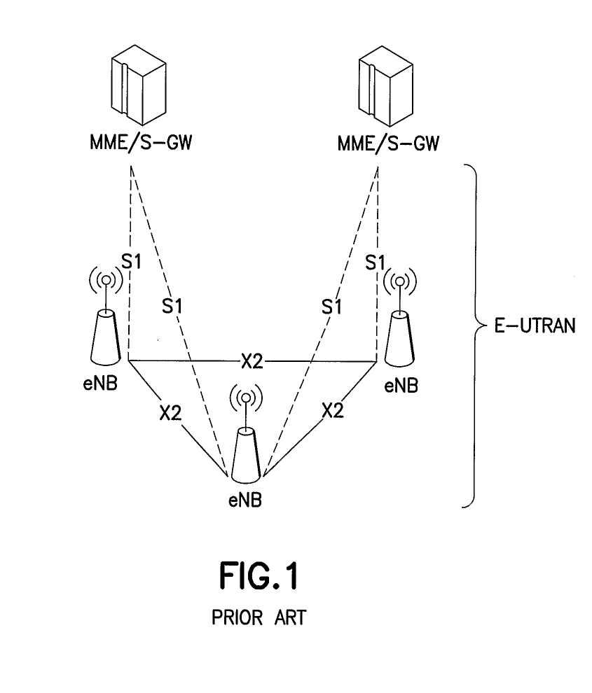

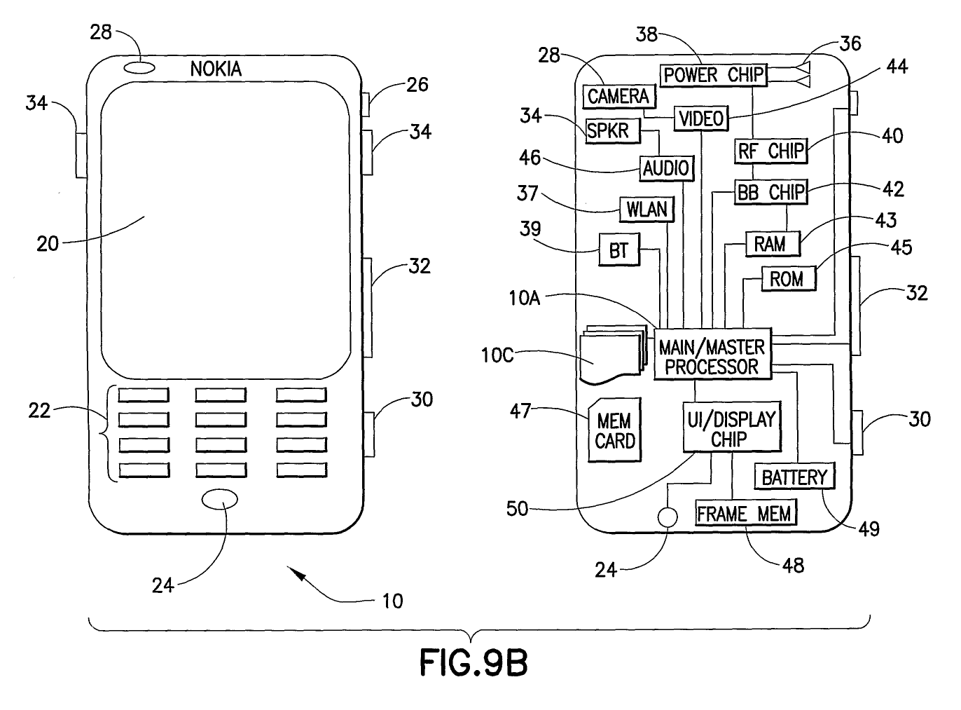

FIG. 9A illustrates a simplified block diagram of various electronic devices and apparatus that are suitable for use in practicing the exemplary embodiments of this invention. In FIG. 9A a wireless network 1 is adapted for communication over a wireless link 11 with an apparatus, such as a mobile communication device which may be referred to as a UE 10, via a network access node, such as a Node B (base station), and more specifically an eNB 12. The network 1 may include a network control element (NCE) 14 that may include the MME/S-GW functionality shown in FIG. 1, and which provides connectivity with a network 1, such as a telephone network and/or a data communications network (e.g., the internet). The UE 10 includes a controller, such as a computer or a data processor (DP) 10A, a computer-readable memory medium embodied as a memory (MEM) 10B that stores a program of computer instructions (PROG) 100, and a suitable radio frequency (RF) transceiver 10D for bidirectional wireless communications with the eNB 12 via one or more antennas. The eNB 12 also includes a controller, such as a computer or a data processor (DP) 12A, a computer-readable memory medium embodied as a memory (MEM) 12B that stores a program of computer instructions (PROG) 12C, and a suitable RF transceiver 12D for communication with the UE 10 via one or more antennas. The eNB 12 is coupled via a data/control path 13 to the NCE 14. The path 13 may be implemented as the S1 interface shown in FIG. 1. The eNB 12 may also be coupled to another eNB via data/control path 15, which may be implemented as the X2 interface shown in FIG. 1.

At least one of the PROGs 10C and 12C is assumed to include program instructions that, when executed by the associated DP, enable the device to operate in accordance with the exemplary embodiments of this invention, as will be discussed below in greater detail. That is, the exemplary embodiments of this invention may be implemented at least in part by computer software executable by the DP 10A of the UE 10 and/or by the DP 12A of the eNB 12, or by hardware, or by a combination of software and hardware (and firmware).

For the purposes of describing the exemplary embodiments of this invention the UE 10 may be assumed to also include a decoder 10E that can selectively decode (blindly) using the open-loop or closed-loop techniques discussed above, and the eNB 12 may include an encoder 12E that can selectively encode using either technique.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multicore processor architecture, as non-limiting examples.

FIG. 9B illustrates further detail of an exemplary UE in both plan view (left) and sectional view (right), and the invention may be embodied in one or some combination of those more function-specific components. At FIG. 9B the UE 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user. The exemplary UE 10 may have a camera 28 which is shown as being forward facing (e.g., for video calls) but may alternatively or additionally be rearward facing (e.g., for capturing images and video for local storage). The camera 28 is controlled by a shutter actuator 30 and optionally by a zoom actuator 30 which may alternatively function as a volume adjustment for the speaker(s) 34 when the camera 28 is not in an active mode.

Within the sectional view of FIG. 9B are seen multiple transmit/receive antennas 36 that are typically used for cellular communication. The antennas 36 may be multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is formed. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and downconverts the signal for baseband processing. The baseband (BB) chip 42 detects the signal which is then converted to a bit-stream and finally decoded. Similar processing occurs in reverse for signals generated in the apparatus 10 and transmitted from it.

Signals to and from the camera 28 pass through an image/video processor 44 which encodes and decodes the various image frames. A separate audio processor 46 may also be present controlling signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22 and elsewhere.

Certain embodiments of the UE 10 may also include one or more secondary radios such as a wireless local area network radio WLAN 37 and a Bluetooth® radio 39, which may incorporate an antenna on-chip or be coupled to an off-chip antenna. Throughout the apparatus are various memories such as random access memory RAM 43, read only memory ROM 45, and in some embodiments removable memory such as the illustrated memory card 47 on which the various programs 10C are stored. All of these components within the UE 10 are normally powered by a portable power supply such as a battery 49.

The aforesaid processors 38, 40, 42, 44, 46, 50, if embodied as separate entities in a UE 10 or eNB 12, may operate in a slave relationship to the main processor 10A, 12A, which may then be in a master relationship to them. Embodiments of this invention are most relevant to the baseband processor 42, though it is noted that other embodiments need not be disposed there but may be disposed across various chips and memories as shown or disposed within another processor that combines some of the functions described above for FIG. 9B. Any or all of these various processors of FIG. 9B access one or more of the various memories, which may be on-chip with the processor or separate therefrom. Similar function-specific components that are directed toward communications over a network broader than a piconet (e.g., components 36, 38, 40, 42-45 and 47) may also be disposed in exemplary embodiments of the access node 12, which may have an array of tower-mounted antennas rather than the two shown at FIG. 9B.

Note that the various chips (e.g., 38, 40, 42, etc.) that were described above may be combined into a fewer number than described and, in a most compact case, may all be embodied physically within a single chip.

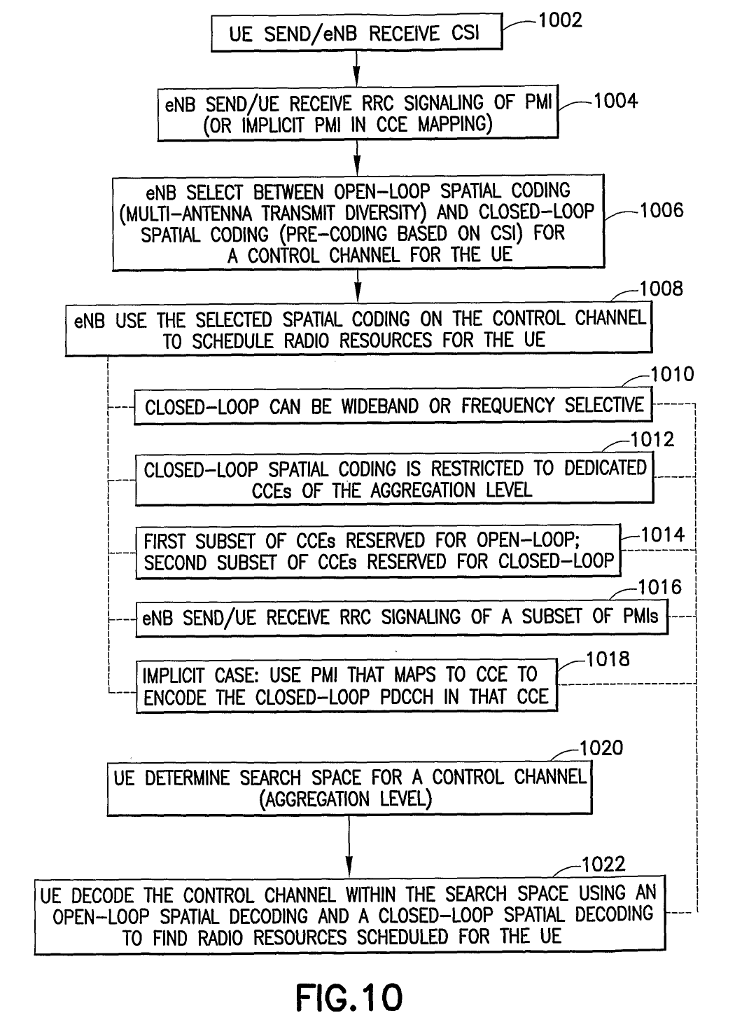

FIG. 10 is a logic flow diagram that comprehensively illustrates for each of the eNB and the UE the operation of a method, and a result of execution of computer program instructions, in accordance with the exemplary embodiments of this invention. In accordance with these exemplary embodiments a method performs, at block 1002 the UE sends and the eNB receives CSI. At block 1004 in one embodiment the eNB sends and the UE receives RRC signaling of PMI, and in another embodiment the PMI is implicit the CCE mapping. At block 1006 the eNB or a component thereof selects between open-loop spatial coding (e.g., multi-antenna transmit diversity) and closed-loop spatial coding (e.g., pre-coding based on CSI) for a control channel (e.g., PDCCH) for the UE. At block 1008 the eNB uses the selected spatial coding on the control channel to schedule radio resources for the UE. From the UE's perspective, at block 1020 the UE determines its search space for a control channel (e.g., from a hashing function that takes into account the aggregation level, subframe index, RNTI, and the number of CCEs within the control region). At block 1022 UE decodes the control channel within the search space using an open-loop spatial decoding and a closed-loop spatial decoding to find radio resources scheduled for the UE.

The blocks to which the dashed lines lead represent the different particular embodiments detailed above. Block 1010 shows that the closed-loop spatial coding can in one embodiment be wideband and in another embodiment be frequency selective. Block 1012 shows the embodiment to limit the UE's blind decoding attempts by which the closed-loop spatial coding is restricted to the PDCCH which is placed in only dedicated CCEs of the aggregation level for that UE. Block 1014 shows the embodiment in which different CCEs are reserved for either closed-loop or open-loop spatial coding: a first subset of CCEs is reserved for open-loop and/or a second subset of CCEs is reserved for closed-loop. Each of these subsets have at least one CCE. Block 1016 shows the embodiment in which the eNB sends and the UE receives RRC signaling of a subset of PMIs which the UE will use for the decoding, and in this embodiment there is more than one PMI in the subset. Finally, block 1018 shows the implicit case in which the eNB and the UE use the PMI that maps to the CCE to encode/decode the closed-loop PDCCH that is placed in that CCE.

The various blocks shown in FIG. 10 may be viewed as method steps, and/or as operations that result from operation of computer program code for the respective eNB and UE separately, and/or as a plurality of coupled logic circuit elements constructed to carry out the associated function(s) for the respective eNB or UE separately.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1-34. (canceled)

35. A method, comprising:
providing to a user equipment precoding information;
selecting closed-loop spatial coding for a control channel for the user equipment;
determining at least one control channel element within the user equipment's search space of the control channel that is associated with the provided precoding information; and
spatially coding the determined at least one control channel element using the provided precoding information to schedule radio resources for the user equipment.

36. The method of claim 35, wherein the selecting is between open-loop spatial coding which is multi-antenna transmit diversity, and closed-loop spatial coding which is multi-antenna pre-coding based on channel state information, and the control channel is a physical downlink control channel.

37. The method of claim 35, wherein providing to the user equipment the precoding information comprises sending the user equipment radio resource control signaling which comprises at least one pre-coding matrix index to use for decoding the spatially coded at least one control channel element.

38. The method of claim 35, wherein the determined at least one control channel element that is associated with the provided precoding information is restricted to dedicated control channel elements of the user equipment's search space.

39. The method of claim 38, wherein the determining is from a locally stored mapping of dedicated control channel elements of the user equipment's search space, in which:
a first subset of the dedicated control channel elements map exclusively to open-loop spatial coding; and
a second subset of dedicated control channel elements map exclusively to closed-loop spatial coding.

40. The method of claim 37, wherein the provided precoding information comprises an indication of a subset of pre-coding matrix indices and the determined at least one control channel element is spatially coded using a pre-coding matrix identified by an index of the subset.

41. The method of claim 40, wherein the subset is selected based on a precoding matrix report received from the user equipment, and the subset includes at least one of:
a precoding matrix index identified in the report; and
a precoding matrix index that is adjacent to a precoding matrix index identified in the report.

42. The method of claim 37, wherein the precoding information is implicit with information sent to the particular user equipment in radio resource signaling that sets the user equipment's search space, in which there is a mapping between pre-coding matrix indices and dedicated control channel elements of the user equipment's search space.

43. The method of claim 42, wherein the mapping comprises at least one of the dedicated control channel elements of the user equipment's search space mapping to at least two distinct precoding matrix indices.

44. An apparatus comprising:
a memory storing program instructions; and
at least one processor;
in which the memory and the program instructions are configured with the at least one processor to cause the apparatus at least to:
provide precoding information to a user equipment;
select closed-loop spatial coding for a control channel for the user equipment;
determine at least one control channel element within the user equipment's search space of the control channel that is associated with the provided precoding information; and
spatially encode the determined at least one control channel element using the provided precoding information for scheduling radio resources for the user equipment.

45. The apparatus of claim 44, wherein the memory and the program instructions are configured with the at least one processor to cause the apparatus to select the closed-loop spatial coding from between open-loop spatial coding which is multi-antenna transmit diversity, and closed-loop spatial coding which is multi-antenna pre-coding based on channel state information.

46. The apparatus of claim 44, wherein the precoding information comprises at least one precoding matrix index, the apparatus further comprising a transmitter configured to send the user equipment radio resource control signaling comprising at least one pre-coding matrix index to use for decoding the spatially coded at least one control channel element.

47. The apparatus of claim 44, wherein the determined at least one control channel element within the user equipment's search space that is associated with the provided precoding information is restricted to dedicated control channel elements of the user equipment's search space.

48. The apparatus of claim 44, wherein the memory comprises a mapping of dedicated control channel elements of the user equipment's search space, in which:
a first subset of dedicated control channel elements of the user equipment's search space that map exclusively to open-loop spatial coding; and
a second subset of dedicated control channel elements of the user equipment's search space that map exclusively to closed-loop spatial coding.

49. The apparatus of claim 46, wherein the memory stores an association of at least one control channel element to a subset of precoding matrices, the apparatus further comprises a transmitter for sending to the user equipment via radio resource control signaling an indication of the subset of pre-coding matrix indices and the apparatus comprises an encoder configured to spatially encode the determined at least one control channel element using a precoding matrix from the subset that is associated in the memory with the at least one control channel element.

50. An apparatus comprising:
a memory storing program instructions; and
at least one processor;
in which the memory and the program instructions are configured with the at least one processor to cause the apparatus at least to:
determine a search space for a control channel;
determine from received radio resource control signaling at least one control channel element within the search space that is to be encoded with closed-loop spatial coding; and
decode the at least one control channel element within the search space using a closed-loop spatial decoding with precoding information associated with the at least one control channel element to find scheduled radio resources.

51. The apparatus of claim 50, wherein for the case where the control channel is not found in the decoded at least one control channel element using the closed-loop spatial decoding which is multi-antenna pre-coding based on channel state information, the memory and the program instructions are configured with the at least one processor to cause the apparatus at least to decode the control channel elements of the search space using the open-loop spatial coding which is multi-antenna transmit diversity.

52. The apparatus of claim 50, further comprising a receiver for receiving the radio resource control signaling comprising at least one pre-coding matrix index;
and wherein the memory and the program instructions are configured with the at least one processor to cause the apparatus to determine the at least one control channel element from a mapping to the pre-coding matrix index that is stored in the memory, and to decode the at least one control channel element using the closed-loop spatial decoding using the received at least one pre-coding matrix index.

53. The apparatus of claim 52, wherein the memory stores a mapping of a first subset of dedicated control channel elements of the search space to the open-loop spatial coding and a mapping of a second subset of dedicated control channel elements of the search space to the closed-loop spatial coding;
and wherein the memory and the program instructions are configured with the at least one processor to cause the apparatus to restrict to the second subset its decoding of the control channel using the closed-loop decoding.

54. The apparatus of claim 50, in which the memory stores a mapping between pre-coding matrix indices and dedicated control channel elements of the search space;
and wherein the memory and the program instructions are configured with the at least one processor to cause the apparatus to decode the control channel using the closed-loop decoding using the pre-coding matrix indices in the dedicated control channel elements to which they map.
